(19) United States
(12) Patent Application Publication
(10) Pub. No.: US 2006/0180089 A1
(43) Pub. Date: Aug. 17, 2006

(54) Unmanned vehicle for displacing manure

(75) Inventor: Karel Van Den Berg, Bleskensgraaf (NL)

Correspondence Address: HOWREY LLP, C/O IP DOCKETING DEPARTMENT, 2941 FAIRVIEW PARK DR., SUITE 200, FALLS CHURCH, VA, 22042, US

(73) Assignee: Lely Enterprises AG

(21) Appl. No.: 11/350,115

(22) Filed: Feb. 9, 2006

(30) Foreign Application Priority Data
Feb. 11, 2005 (NL) 1028259

(51) Int. Cl. A01K 1/10

(52) U.S. Cl. 119/60

(57) ABSTRACT

An unmanned vehicle for displacing manure over the floor of a stable, comprising a steering unit for steering the vehicle and moving it in a direction of travel, a frame and manure displacing element for displacing manure. The unmanned vehicle is provided with a device for riding over an obstacle, which device is disposed, seen in the direction of travel, before the manure displacing element.

### CROSS REFERENCE TO RELATED APPLICATIONS

This application claims priority from Netherlands application number 1028259 filed on 11^{th} Feb. 2005, the contents of which are hereby incorporated by reference in their entirety.

### BACKGROUND OF THE INVENTION

1. Field of the Invention

The invention relates to unmanned vehicles for displacing manure, in particular for displacing such manure in a stable or cowshed.

2. Description of the Related Art

Unmanned vehicles for displacing manure over the floor of a stable have been described in which a steering unit is provided for steering the vehicle and moving it in a direction of travel. Such vehicles may also comprise a frame and a manure displacing element for displacing the manure. An example of such a vehicle is given in European patent application No. EP A 0 943 235, the content of which is hereby incorporated by reference in its entirety. Although known unmanned vehicles generally function properly, it has been found that, in particular when using a rigid manure slide as a manure displacing device, it is possible for the unmanned vehicle to catch behind small obstacles projecting from the floor of a stable, such as bolt heads or grid parts that are not located at the same level. Moreover, it has been found that smaller thresholds of approximately 20 mm height cannot be taken by the unmanned vehicle.

Thus, there is a particular need for a device that can at least partially obviate the above-mentioned drawbacks.

### BRIEF SUMMARY OF THE INVENTION

The present invention addresses these problems by providing an unmanned vehicle of the above-described type having a steering unit for steering the vehicle and moving it in a direction of travel, a frame, a manure displacing element for displacing the manure and a device for riding over an obstacle. The device for riding over an obstacle is disposed ahead of the manure displacing element, as seen in the direction of travel. Furthermore, the device is arranged to not be in rolling contact with the floor in the normal operative position of the unmanned vehicle. In other words, the device is not acting as a wheel in the normal sense of operation. The advantage of this unmanned vehicle is that the device for riding over an obstacle is capable of lifting the unmanned vehicle over smaller projecting obstacles and/or smaller thresholds, so that the unmanned vehicle will not undesirably come to a standstill. This makes it possible to displace manure more accurately and completely and relatively quickly from the floor of a stable.

In an embodiment of an unmanned vehicle according to the invention, the device is disposed on the unmanned vehicle in such a way that it is located at some distance above the floor in the normal operative position of the unmanned vehicle. Exemplary devices that may be used include for example, a wheel, roll, bar, sliding shoe or the like. The distance from the device to the floor is preferably adjustable. Although the device is usually out of contact with the floor, on contacting an obstacle, the device may roll or slide over the obstacle, causing the unmanned vehicle or the manure displacing element to rise up sufficiently to pass the obstacle. Preferably, the device is located at a distance of around 1 inch above the floor.

In an alternative embodiment of an unmanned vehicle according to the invention, the device is disposed on the unmanned vehicle in such a way that it is generally in contact with the floor in the normal operative position of the unmanned vehicle. In this case, the device for riding over an obstacle is preferably in the form of a sliding shoe. It is noted that even in such an embodiment where the device is normally in contact with the floor, the sliding shoe may comprise a wheel like device e.g. arranged to turn about a vertical axis.

The sliding shoe has preferably beveled edges. If the sliding shoe is round or at least partially disk shaped, smaller obstacles and/or smaller thresholds can be bridged, irrespective of the position of the sliding shoe relative to said obstacles and/or thresholds. More preferably, a lower surface of the sliding shoe is at least partially lens or discus shaped and has a diameter which decreases in the direction of the floor of a stable. It is then possible for the sliding shoe to slide in a simple manner over smaller obstacles and/or smaller thresholds.

The device for riding over an obstacle is advantageously directly fastened to the frame, so that the entire frame is lifted when the device slides over smaller obstacles and/or smaller thresholds, so that sudden forces caused by sliding over smaller obstacles and/or smaller thresholds are absorbed by the entire unmanned vehicle.

The device for riding over an obstacle is alternatively fastened to the manure displacing element, it being in particular advantageous if the manure displacing element is suspended from the frame in such a way that it is capable of swivelling. In this manner it is ensured that, when the device slides over a smaller, discrete obstacle, the manure displacing element is moved in such a swivelling way that it is possible for the manure displacing element, and consequently the unmanned vehicle, to pass along the smaller obstacle in a simple manner.

The manure displacing element advantageously comprise a manure slide, so that the manure can be slid from the floor. The manure slide is preferably made of flexible material, the flexibility being chosen in such a way that, when displacing manure, the manure slide will at least substantially keep its shape, whereas, when colliding with a small obstacle that is rigidly fitted in or on the floor, the manure slide will deform in such a way that it is capable of passing along the obstacle.

In an embodiment of an unmanned vehicle according to the invention which is extremely advantageous for displacing manure, the manure slide has a curved shape and two free ends, the free ends being located further in the direction of travel than the other components of the manure slide. The device is then preferably partially located in the area formed by the imaginary line between the free ends of the manure slide and the manure slide itself.

In a further embodiment of an unmanned vehicle according to the invention, the unmanned vehicle is provided with a propelling device comprising wheels for propelling the unmanned vehicle, only the wheels and the manure displacing element being necessary for supporting the unmanned vehicle in the normal operative position, the device for riding over an obstacle being disposed, seen in the normal direction of travel, before the wheels and the manure displacing element. In other words, the device for riding over an obstacle is not necessary for supporting the unmanned vehicle, so that the device can be detachably disposed on the unmanned vehicle, and the unmanned vehicle can also be used without the device for riding over an obstacle.

### BRIEF DESCRIPTION OF THE DRAWINGS

The invention will now be explained in further detail with reference to a number of exemplary embodiments as shown in the drawings, in which:

FIG. 1 is a schematic plan view of the unmanned vehicle according to the invention,

FIG. 2 is a schematic side view of the unmanned vehicle according to the invention,

FIG. 3 is a schematic front view of the unmanned vehicle according to the invention, and

FIG. 4 is a schematic perspective view of a curved manure slide with sliding shoe of the unmanned vehicle according to the invention.

### DESCRIPTION OF ILLUSTRATIVE EMBODIMENTS

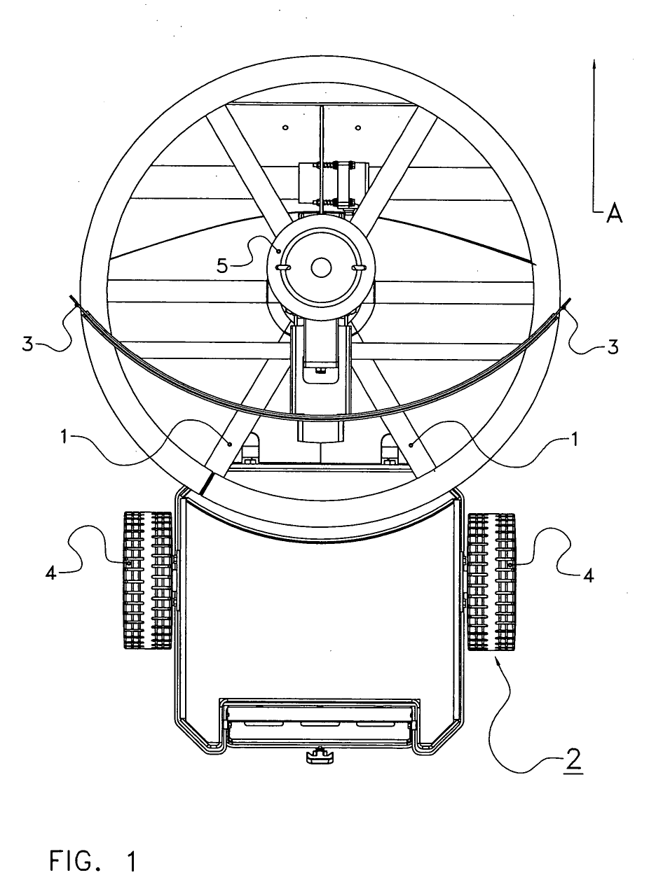

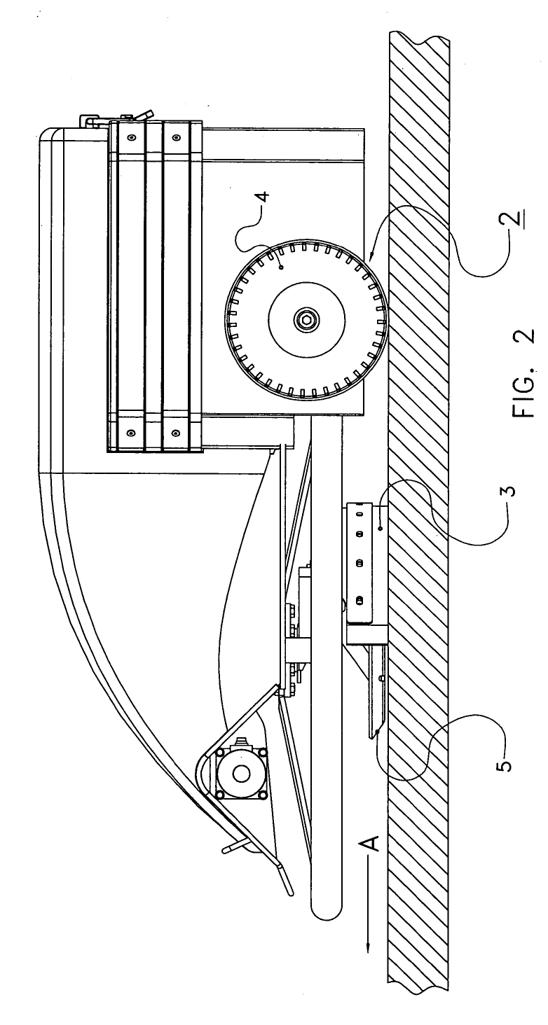

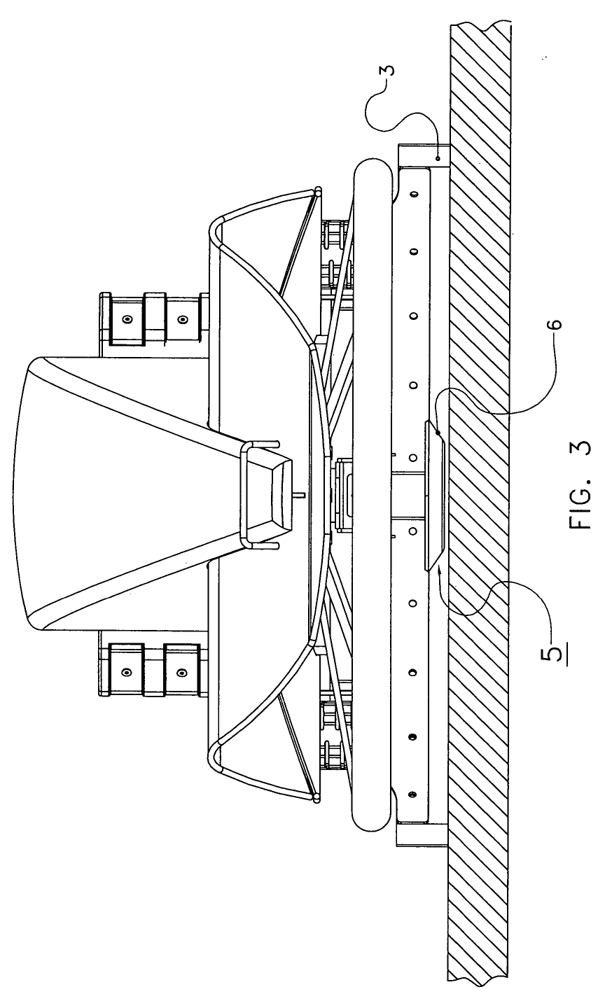

The unmanned vehicle as shown in FIGS. 1 to 3 consists of a body or frame 1 on which a propelling device 2 and a manure slide 3 are disposed, although other manure displacing element, such as grippers and the like, may be used as well. In the embodiment shown, the steering unit comprises the propelling device 2, which comprises two independently driven wheels 4. Alternatively, the steering unit may comprise a controllable wheel or roller which is capable of pivoting in the direction of travel. In this embodiment, maneuvering the vehicle is possible by varying the drive torque or the peripheral velocity of the wheels 4. The wheels 4 may comprise a wheel and/or a caterpillar track.

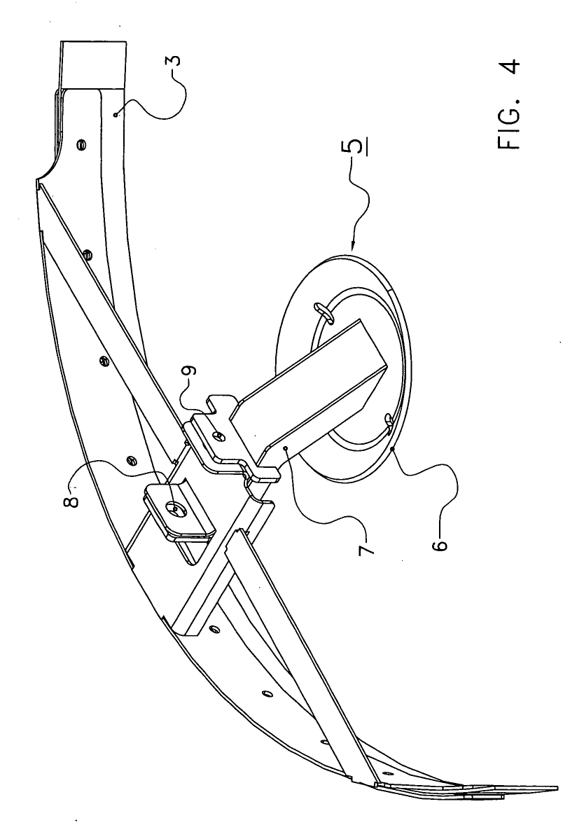

The unmanned vehicle is provided with a sliding shoe 5 which, seen in the direction of travel A, is disposed before the manure slide 3. In the embodiment shown schematically in a perspective view in FIG. 4, the sliding shoe 5 is round and has a bevelled edge 6, so that the sliding shoe 5 has a diameter which decreases in the direction of the floor of a stable. This makes it possible for the sliding shoe 5 to slide in a simple manner over smaller obstacles and/or thresholds. Via a fastening device 7, the sliding shoe 5 is fastened to the manure slide 3, which is suspended itself, via an axis indicated by the apertures 8 and 9 in the fastening device 7, from the frame in such a way that it is capable of swivelling. By pressure generating means known per se it is then possible for the manure slide to be pressed against the floor, with adjustable force if desired, for effectively displacing manure. Although not shown in the figures, the manure slide 3 may also be suspended in such a way that it is capable of swivelling in a direction perpendicular to the direction defined by the apertures 8 and 9, for example by means of a drawbar, a parallelogram construction or in general by means of two hinges.

In a non-shown alternative embodiment, the sliding shoe may be fastened directly to the frame. Furthermore, the invention may be applied while using other means than a sliding shoe for riding over an obstacle, which means are in contact with the floor in the normal operative position of the unmanned vehicle. Alternatively, the device for riding over an obstacle may be disposed on the unmanned vehicle in such a way that, in the normal operative position, said device, for example in the form of a wheel, roll, bar or the like, is located at some (preferably adjustable) distance from the floor.

In the embodiment shown in the figures, the manure slide 3 is made of flexible material. In this case, the flexibility is chosen in such a way that, when displacing manure, the manure slide will at least substantially keep its shape, whereas, when colliding with a small obstacle that is rigidly fitted in or on the floor, the manure slide will deform in such a way that it is capable of passing along the obstacle. The manure slide 3 shown in the figures is also curved and has two free ends, which are located further in the direction of travel than the other parts of the manure slide 3. As is apparent from FIG. 1, the sliding shoe 5 is partially located in the area formed by the imaginary line between the ends of the manure slide 3 and the manure slide 3 itself.

The unmanned vehicle is supported by the wheels 4 and the manure slide 3, the sliding shoe 5 not being necessary for the support of the unmanned vehicle. Seen in the normal direction of travel A, the sliding shoe 5 is located ahead of the supporting components of the unmanned vehicle, i.e. ahead of the wheels and the manure slide.

It will be obvious that the invention is not limited to the preferred embodiments of the unmanned vehicle shown in the figures and described in the foregoing, but that numerous modifications are possible within the scope of the accompanying claims. The manure slide as well as the sliding shoe may, for example, be designed linearly. Furthermore, the sliding shoe may be detachably fastened to the unmanned vehicle, so that it is possible to use the unmanned vehicle with and without sliding shoe.

Many modifications in addition to those described above may be made to the structures and techniques described herein without departing from the spirit and scope of the invention. Accordingly, although specific embodiments have been described, these are examples only and are not limiting upon the scope of the invention

What is claimed is:

1. An unmanned automated vehicle for displacing manure over the floor of a stable, comprising:
a steering unit for steering the vehicle and moving it in a direction of travel;
a frame;
a manure displacing element for displacing the manure; and
a device for riding over an obstacle, the device being disposed ahead of the manure displacing element in the direction of travel and not being in rolling contact with the floor in the normal operative position of the unmanned vehicle.

2. An unmanned vehicle as claimed in claim 1, wherein the device is disposed on the unmanned vehicle in such a way that it is located a distance above the floor in the normal operative position of the unmanned vehicle.

3. An unmanned vehicle as claimed in claim 2, wherein the distance from the device to the floor is adjustable.

4. An unmanned vehicle as claimed in claim 1, wherein the device is disposed on the unmanned vehicle in such a way that it is in sliding contact with the floor during normal operation of the unmanned vehicle.

5. An unmanned vehicle as claimed in claim 4, wherein the device is a sliding shoe.

6. An unmanned vehicle as claimed in claim 5, wherein the sliding shoe has bevelled edges.

7. An unmanned vehicle as claimed in claim 5, wherein the sliding shoe is at least partially disk shaped.

8. An unmanned vehicle as claimed in claim 1, wherein the device is directly fastened to the frame.

9. An unmanned vehicle as claimed in claim 1, wherein the device is fastened to the manure displacing element.

10. An unmanned vehicle as claimed in claim 1, wherein the manure displacing element is suspended from the frame in such a way that it is capable of swiveling.

11. An unmanned vehicle as claimed in claim 1, wherein the manure displacing element comprises a manure slide.

12. An unmanned vehicle as claimed in claim 11, wherein the manure slide is made of flexible material.

13. An unmanned vehicle as claimed in claim 11, wherein the manure slide is curved and has two free ends, the free ends being located further in the direction of travel than the other components of the manure slide.

14. An unmanned vehicle as claimed in claim 13, wherein the device is partially located in an area formed by an imaginary line between the free ends of the manure slide and the manure slide itself.

15. An unmanned vehicle as claimed in claim 1, wherein the unmanned vehicle is provided with a propelling device comprising generally coaxial wheels for propelling the unmanned vehicle, only the wheels and the manure displacing element being necessary for supporting the unmanned vehicle in the normal operative position, the device for riding over an obstacle being disposed, seen in the normal direction of travel, ahead of both the wheels and the manure displacing element.

16. An unmanned vehicle as claimed in claim 1, wherein the device for riding over an obstacle is detachably disposed on the unmanned vehicle.

17. An unmanned automated vehicle for displacing manure over the floor of a stable, comprising:
a body;
a pair of generally coaxial wheels located beneath the body for steering the vehicle and moving it in a direction of travel;
a manure displacing element disposed beneath the body and ahead of the wheels in the direction of travel, a weight of the body being supported on the floor only by the wheels and the manure displacing element such that the manure displacing element is pressed into wiping contact with the floor; and
a device for riding over an obstacle, the device being disposed beneath the body and ahead of the manure displacing element and being spaced a short distance from the floor in the normal operative position of the unmanned vehicle.

18. An unmanned vehicle as claimed in claim 1, wherein the device is an at least partially disk shaped slide having a convex lower surface.

19. An unmanned vehicle as claimed in claim 18, wherein the manure displacing element comprises a manure slide made of flexible material.

20. An unmanned vehicle as claimed in claim 19, wherein the manure slide is curved and has two free ends, the free ends being located further in the direction of travel than the other components of the manure slide and the device is partially located in an area formed by an imaginary line between the free ends of the manure slide and the manure slide itself.
